(19) United States
(12) Patent Application Publication
(10) Pub. No.: US 2014/0349764 A1
(43) Pub. Date: Nov. 27, 2014

(54) METHODS AND SYSTEMS OF GENERATING A PLAYER TO PLAYER CASINO

(71) Applicant: Adam Jae Chun Lee, Honolulu, HI (US)

(72) Inventor: Adam Jae Chun Lee, Honolulu, HI (US)

(21) Appl. No.: 14/286,972

(22) Filed: May 23, 2014

Related U.S. Application Data
(60) Provisional application No. 61/827,447, filed on May 24, 2013.

(51) Int. Cl. G07F 17/32

(52) U.S. Cl. CPC G07F 17/3225
USPC 463/42

(57) ABSTRACT

A system for generating a peer-to-peer (p2p) casino table is provided. The system includes a peer-to-peer (p2p) engine. The p2p engine is configured to create a casino table for play between a first user making an initial wager and a second user making a cover wager that covers at least a portion of the initial wager. The system also includes an interface coupled to the p2p engine and configured to receive data from the first user and the second user. The system also includes a management engine coupled to the p2p engine. The management engine is configured to audit the casino table.

### CROSS-REFERENCE TO RELATED APPLICATIONS

This application claims priority to provisional application No. 61/827,447 filed May 24, 2014, and incorporates the contents of that application by reference in its entirety.

### BACKGROUND OF THE DISCLOSURE

Current internet based casino games are popular avenues for gambling. In currently known internet based casino games, a player wagers on the outcome of an event in a game. Typical games include, pai gow, poker, blackjack, craps, baccarat, roulette, and any other known or conventional gambling game. A second entity, known as the house, accepts all wagers placed in the game, up to the maximum bet amount allowed. The house is responsible for covering all wagers from players, and paying players on winning outcomes. In return the house receives the proceeds of wagers on losing outcomes. To generate revenue, the house generally has a statistical advantage in the game such that over a large number of bets the machine returns only a percentage of the amount bet. The percentage of bets not returned to players is commonly referred to as “house edge,” “vig,” “cut,” “take,” and/or “juice.” Although the juice varies depending on the game, known casino games typically operate with 1-20% juice. While this format is lucrative for the house, many players do not play games where the house has a substantial advantage over the player, or when they do play, the players bet relatively low amounts solely for the entertainment value.

As known casino games are designed with the odds stacked in favor of the house, players' entertainment and enjoyment is reduced, which in turn reduces playing time and revenue for the casino. Additionally, the imbalanced odds may generate a negative view of the casino and its operators. Accordingly, it may be advantageous to provide a peer-to-peer gaming system that enables a first player to bet directly against a second player with even or substantially even odds between the two players.

The foregoing examples of the related art and limitations related therewith are intended to be illustrative and not exclusive. Other limitations of the related art will become apparent upon a reading of the specification and a study of the drawings.

### BRIEF DESCRIPTION OF THE DISCLOSURE

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

Herein, there is provided a system and method for providing a player-to-player gambling platform that is able to create and match bets between a first player and a second player on a casino gambling game. More specifically, a betting player makes an initial wager on an event in a gambling game, and a covering player acts as a house typically would and covers the betting player's wager. Multiple users can play simultaneously as “the player” on a table for any given bet. Further, each user can play on multiple tables at one time, whether as the house or as a player. In this manner, the system can allow individual users to elect to play as either player or house on a bet-by-bet basis.

Accordingly, a user can place a bet as a player and lay a bet as the house, all simultaneously and within a single betting round. Users acting as players first place the bets and the users acting as house lay the bets. On any given table you could have multiple players placing multiple bets and multiple houses laying multiple bets, and these users could each be playing as player or house. In addition, a user may act as both the betting player and the covering player in a single round of a game. For example a first user may act as the betting player for one event, e.g., betting red on a roulette spin, and also act as a covering player by accepting a second user's bet, e.g., betting that the roulette spin will land on double green. Any leftover bets will be refunded to the player or can be taken by a user or entity that is the “constant secondary house” to provide an efficient method of liquidation for all bets that are placed but not initially laid by a user or users acting as house. Such a system can be provided electronically via an interface to a computing system. The system can operate via a player-to-player (p2p) engine operating under the supervision of a management engine where the p2p engine provides casino games to users in a p2p environment via an interface.

The system further includes a management system that determines sufficient capitalization of both the betting player and the cover player to pay winning outcomes. The management system may also determine if any events, security, financial, or other require suspension of betting by any of the players. In some embodiments, the management system may send alerts to players based on triggers associated with the betting. For example, if capitalization is reduced below an amount needed to pay for a possible outcome, e.g. insufficient funds to cover a roulette spin landing on the correct number, the management system may send an alert to the player. The management system further reconciles accounts between the betting player and covering player at the conclusion of reach round or at the conclusion of a betting session. After each outcome, or playing session, the management system credits the account of the player associated with the winning outcome and debits the account of the player associated with the losing outcome. In one embodiment, the management system may set aside a percentage of the amount bet between the betting player and the covering player as a service fee.

Such a system can be provided electronically via an interface to a computing system. The system can operate via a player-to-player (p2p) engine operating under the supervision of a management engine where the p2p engine provides various casino themes and games to users in a p2p environment via an interface. The interface displays the wagers of other players associated with a selected game and allows players to place a new wager or cover an existing wager. In one embodiment, the system may facilitate matching separately placed but opposed wagers. Additionally, the management engine may provide suggested bets based on previous betting histories.

The management system may provide numerous alerts and information to a player. For example, alerts may be sent when the player has won or lost a certain amount of money, when a certain amount of aggregate handle has been played, when a bet on a particular team has been placed, when a new wager in a specified game is placed, when a particular player has made a wager, and/or other similar information.

Advantageously users can play in an even-odds environment thereby increasing their chances of winning as compared with a traditional casino environment where “the house has the advantage.” Such an environment can provide the users with an improved experience by allowing advantage-free, fair play.

Additionally or alternatively, such a system can be provided as a stand-alone device or series of devices in the form of a typical casino gaming machine networked and inter-operable with a web-based casino. The web-based casino may allow access to the network for on premise only gaming and/or on-premise and off-premise gaming. In such an embodiment, for example, a live dealer may perform physical acts, such as, without limitation deal cards, spin a roulette wheel, throw dice, etc. while players both physically present and online make wagers on the outcome.

### BRIEF DESCRIPTION OF THE DRAWINGS

FIG. 1 depicts an example of a system for providing a player-to-player casino.

FIG. 2 depicts a flow chart of an example of a method for defining a table for play within a player-to-player casino.

FIG. 3 depicts a flow chart of an example of a method for defining a table for play within a player-to-player casino.

FIG. 4 depicts a flow chart of an example of a method for capitalizing an account for play within a player-to-player casino.

FIG. 5 depicts a flow chart of an example of a method for operating a table for play within a player-to-player casino.

FIG. 6 depicts a flow chart of an example of a method for managing a table within a player-to-player casino.

FIG. 7 depicts a flow chart of an example of a method for auditing a table within a player-to-player casino.

FIG. 8 depicts a flow chart of an example of a method for managing a failed table audit within a player-to-player casino.

FIG. 9 depicts an example of a system for providing a player-to-player casino.

### DETAILED DESCRIPTION OF THE DISCLOSURE

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

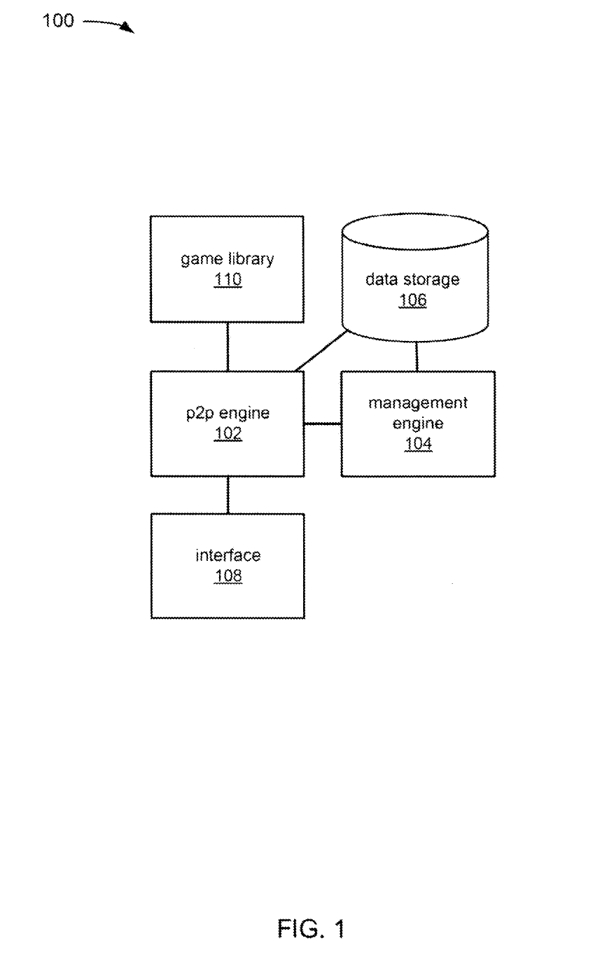

FIG. 1 depicts an example of a system 100 for providing a player-to-player casino. FIG. 1 includes game library 110, p2p engine 102, management engine 104, data storage 106 and interface I08.

In the example of FIG. 1, game library 110 can be a programming library of functions useful to provide popular casino games. For example, game library 110 can include a collection of functions for displaying cards, counting chips, rolling dice, or otherwise providing games for a user of a casino game. Such games can include, e.g., craps, roulette, baccarat, or any other known or convenient casino games. New games may be added as they are created.

In the example of FIG. 1, p2p engine 102 can include a computer processor coupled to memory storing instructions for execution by the processor. The p2p engine 102 creates, operates, closes and otherwise runs all tables within the p2p casino. These operations can generate a significant amount of data and the p2p engine 102 stores such data within data storage 106. Further, the operation of the p2p engine 102 includes the debiting and crediting of user accounts for funds to capitalize a table where associated financial data is stored in data storage 106.

In the example of FIG. 1, management engine 104 can include a computer processor coupled to memory storing instructions for execution by the processor. The management engine 104 can audit records created by p2p engine 102 and has the power to require p2p engine 102 to suspend a table for financial, security or other known or convenient reasons. For example, management unit 104 can perform one or more of the methods included herein to monitor and audit table activity.

In the example of FIG. 1 data storage 106 can be a data repository for storing information associated with a p2p casino. As used in this paper, a “repository” can be implemented, for example as software embodied in a physical computer-readable medium on a general-purpose or specific-purpose machine, in firmware, in hardware, in a combination thereof, or in any applicable known or convenient device or system.

The repositories described in this paper are intended, if applicable, to include any organization of data, including tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, FileMaker, Informix, Microsoft Access, Microsoft SQL Server, Microsoft Visual FoxPro, MySQL, and Openoffice.org Base, to name several. However, any known or convenient DBMS can be used.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 1, interface 108 can be one or more of a graphical user interface for directly communicating with a user at a computing system operating the p2p casino table, a data interface operable to service a user via a communication link to a separate computing device, or any known or convenient interface for communicating the operation of the p2p casino table with a user. Such an interface can be useful for communicating over a network, such as the internet.

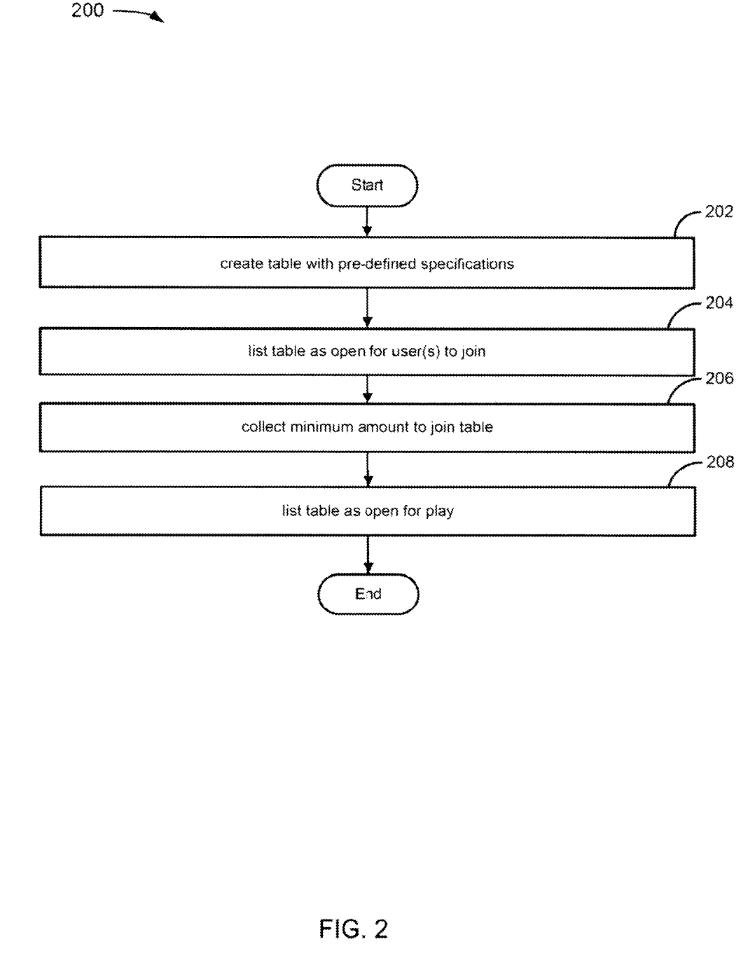

FIG. 2 depicts a flow chart 200 of an example method for defining a table for play within a p2p casino. The method is organized as a sequence of modules in flowchart 200, however it should be understood that these and other modules associated with other methods described herein may be reordered for parallel execution or into different sequences of modules.

In the example of FIG. 2, the flowchart starts at module 202 with create table with pre-defined specifications. In creating a casino game, a library may be used to provide a table game of common use; for example a standard casino table may include definitions for limits per round of betting, maximum odds-bets, minimum bet, and other known or convenient table game specifications. Similarly, standard blackjack, craps, baccarat, and/or other tables may include similar values relevant to such casino games. There is some convenience in offering a casino game with pre-defined specifications; a user may not wish to define all values for a table and may instead use a predefined template of table values.

In the example of FIG. 2, the flowchart continues to module 204 with list table as open for user(s) to join. In entering a table as open for user(s) to join, the table can be required to specify a minimum of at least one user to open the table. Such requirements and availability of the table can be saved to data storage. Once the table is listed, users can view the table, as well as other open tables, via an interface.

In the example of FIG. 2, the flowchart continues to module 206 with collect minimum amount to hold table open from user. One or more users can play as the player or house on any given bet by placing or laying a bet or bets. Each such user can be required to have sufficient funds to play; “sufficient funds” can vary from table to table and from game to game, but one method of determining sufficient funds is to identify the maximum loss that the bet could experience in a round and require the user to maintain that amount as available, whether they are placing the bet as a player or laying the bet as a house. For some bets there will be multipliers factored in to the payout amount, which will be factored in to the amount of sufficient funds that are required to place or lay the bet and play the round. Alternatively, a minimum amount could be required of the user in order to open the table. In the example of FIG. 2, the flowchart continues to module 208 with list table as open for play. This table can then be entered into a data store as having met the requirements to allow users to join and play. Then when a user requests a list of available tables, the table can be provided to the user as a part of that list. Having listed table as open for play, the flowchart terminates.

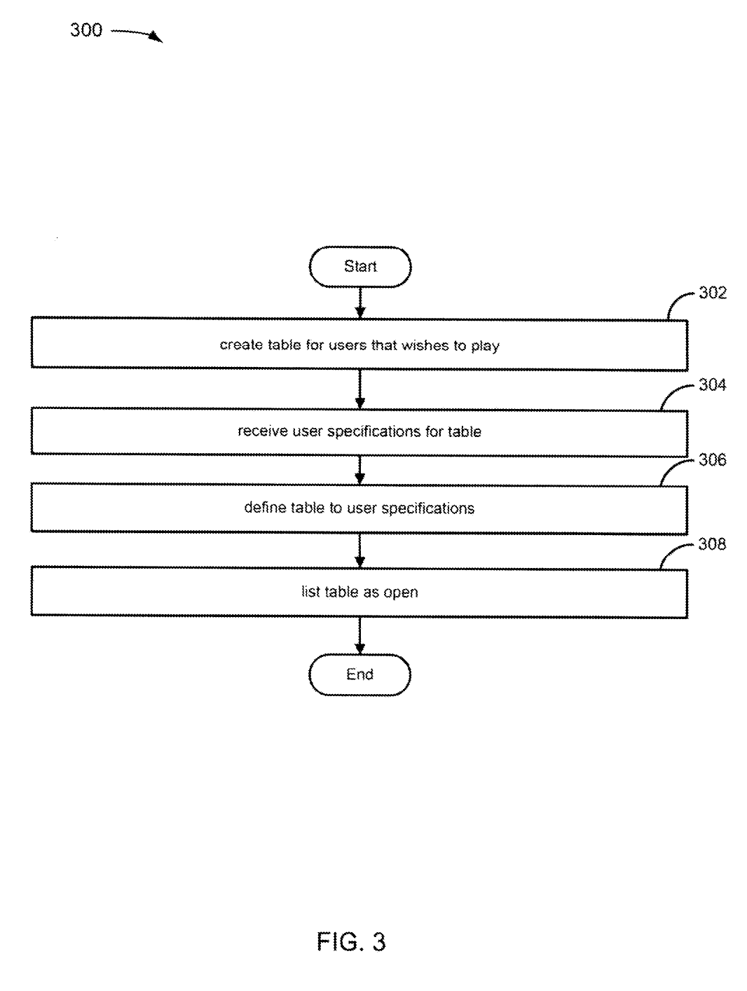

FIG. 3 depicts a flow chart 300 of an example of a method for defining, a table for play within a player-to-player casino. The method is organized as a sequence of modules in the flowchart 300, however, it should be understood that these and other modules associated with other methods described herein may be reordered for parallel execution or into different sequences of modules.

In the example of FIG. 3, the flowchart starts at module 302 with creating table for a user that wishes to play. Here a user can be requesting a table as well as certain parameters of the table. For example, the user may wish to limit the number of players to a certain sized table, restrict players to his or her friends, set a table limit of a certain dollar amount, or otherwise define the table to his or her specific specifications.

In the example of FIG. 3, the flowchart continues to module 304 with receive user specifications for table. The user can transmit the specifications to the p2p casino via an interface and the specifications can be received and stored into a data store for the p2p casino. Such a transmission can be made by the internet, a local network, direct entry by the user into the computing system, or other known or convenient path.

In the example of FIG. 3, the flowchart continues to module 306 with define table to user specifications. The table specifications can be entered into a data store as defining a particular table. Such specifications can be used by a p2p engine in conjunction with a game library to provide that table. Additionally, a management engine can use the specifications in monitoring and auditing the table.

In the example of FIG. 3, the flowchart continues to module 308 with list table as open. Listing a table as open can include making an entry in a data store that a particular table is open for play. Once the table has been listed as open, users can receive the table in responses to their requests for open tables. Having listed table as open, the flowchart terminates.

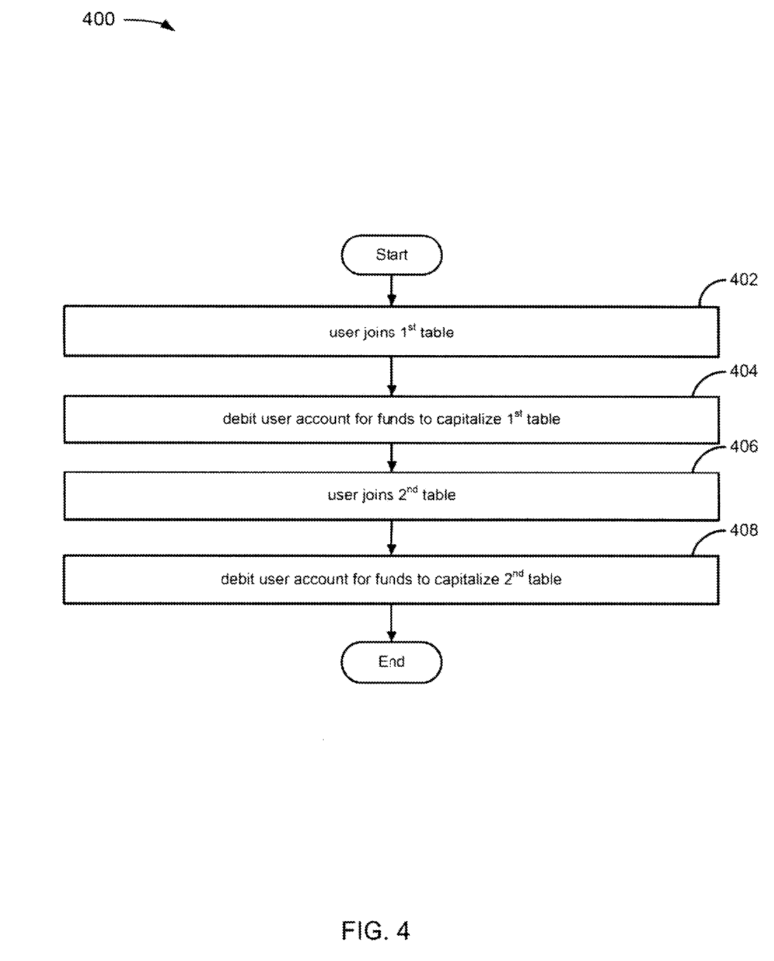

FIG. 4 depicts a flow chart 400 of an example of a method for capitalizing a table for play within a player-to-player casino. The method is organized as a sequence of modules in the flowchart 300, however, it should be understood that these and other modules associated with other methods described herein may be reordered for parallel execution or into different sequences of modules.

In the example of FIG. 4, the flowchart starts at module 402 with user joins a first table. When a user joins a table, the act of joining can be reflected as an entry into a data store. This entry can associate the user with the identified table such that a p2p engine treats the player as a user on the table. Such data can be accessible to both the p2p engine and a management engine in operating and managing the table.

In the example of FIG. 4, the flowchart continues to module 404 with debit user account for funds to capitalize an account to play at the 1st table. A table can have a requirement for the amount of funds needed to play on that table. A p2p engine can debit the required funds from an account associated with that user, or alternatively mark such funds as allocated to the 1sr table. Such allocation or debiting can ensure that the user will not fail to make payment for the first table, should he or she lose. The amount of the funds can be determined in part by whether the user is playing as the house or as a player. Enough funds should be deducted so that the user will meet his or her maximum loss on that table, or at least a defined portion of that loss if a margin or similar system is used.

In the example of FIG. 4, the flowchart continues to module 406 with user joins a second table. The user can play on more than one table at the same time, subject to his or her ability to pay. In joining the second table an entry can be made into a data store specifying that the user is now playing on the identified table. When information about the table is requested the user will be identified as playing on the particular table.

In the example of FIG. 4, the flowchart continues to module 408 with debit user account for funds to capitalize an account to play at the 2nd table simultaneously or exclusively. The user's ability to pay for any losses can be ensured when the user joins the table. This can be accomplished by specifying an amount of funds to mark, escrow, set aside or otherwise make available solely for payment of losses for bets made at the second table, whether placing or laying a bet. Having debited user account for funds to capitalize 2nd table, the flowchart terminates.

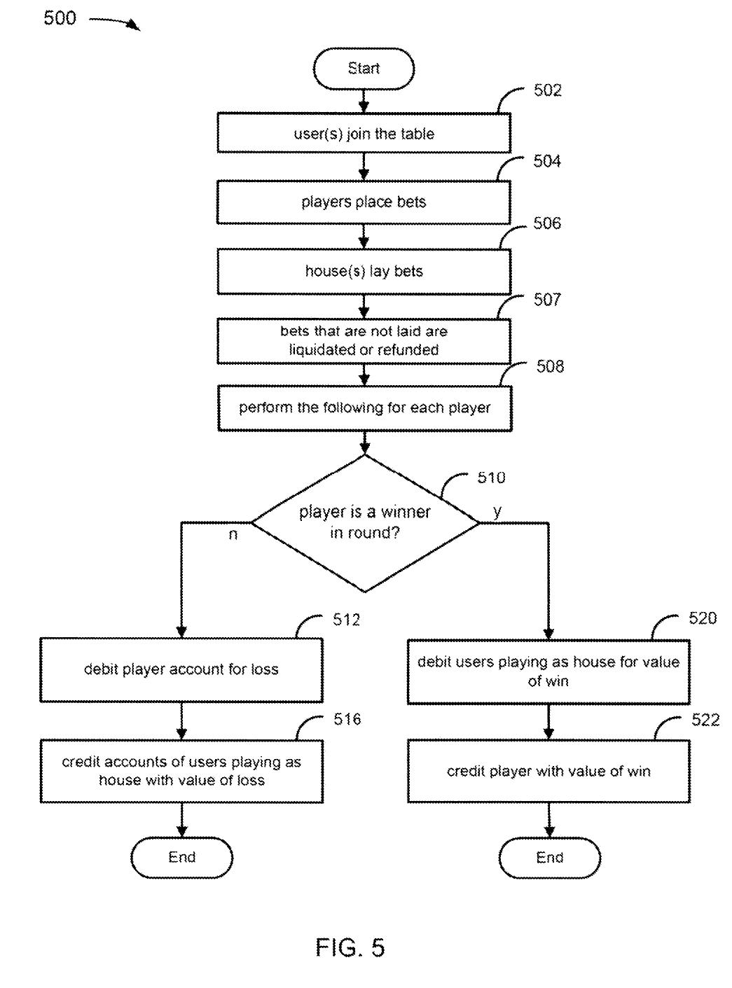

FIG. 5 depicts a flow chart 500 of an example of a method for operating a table for play within a player-to-player casino. The method is organized as a sequence of modules in the flowchart 500, however, it should be understood that these and other modules associated with other methods described herein may be reordered for parallel execution or into different sequences of modules.

In the example of FIG. 5, the flowchart starts at module 502 with user(s) joining the table. The user can be required to have sufficient funds to cover losses of bets placed or laid, and can place those funds into an account associated with the table. One or more users can play as the house or player simultaneously, placing and laying bets against each other. One or more users can join the table at any given time, taking into consideration any restrictions the table may have on the maximum number of users allowed at a time. Each such user can provide a minimum amount required to play a round on the table. Such an amount can vary from game to game.

In the example of FIG. 5, the flowchart continues to module 504 with players placing bets. Here, each player selects a bet to make and enters the bet on the table.

In the example of FIG. 5, the flowchart continues to module 506 with user or users acting as house laying the bets. The users select the various bets and lay them, meaning, the users pick individual bets and agree to pay the users in the even the bet is successful.

In the example of FIG. 5, the flowchart continues to module 507 with a user or an entity that is designated to act as the “Clearing House” and lay all left over bets as well as refunding any bets that are placed, but not laid.

In the example of FIG. 5, the flowchart continues to module 508 with performing the following for each player. This module refers to repeating the remaining modules below, including module 510 and then module 512 through 516 or alternatively, module 520 through 522 for each player on the table.

In the example of FIG. 5, the flowchart continues to decision module 510 with determining whether player is a winner in round. The player is determined to be a winner in the round in accordance with the rules of the game being played on the particular table, e.g. the rules of blackjack, the rules of roulette, or rules of another known or convenient game. If the decision at 510 is no the flowchart proceeds to module 512. If the decision at 510 is yes then the flowchart proceeds to module 518.

In the example of FIG. 5, if the decision at 510 is no, the flowchart continues from decision module 510 to module 512 with debit player account for loss. In accordance with the rules for the game being played, an amount for the loss IS deducted from the player's account.

In the example of FIG. 5, the flowchart continues to module 516 with credit accounts of users playing as house with value of loss. This credit will deliver the winnings each user playing as house will receive from this specific player's bet. Having credited accounts of users playing as house with portion of loss, the flowchart terminates.

In the example of FIG. 5, if the decision at 510 is yes, the flowchart continues from decision module 510 to module 520 with debit users playing as house for portion of value of the win. The amount required from each user playing as house is collected from the user's account.

In the example of FIG. 5, the flowchart continues to module 522 with credit player with value of win. Here, the amount collected in the previous module can be delivered to the winning player. Having credited player with value of win, the flowchart terminates.

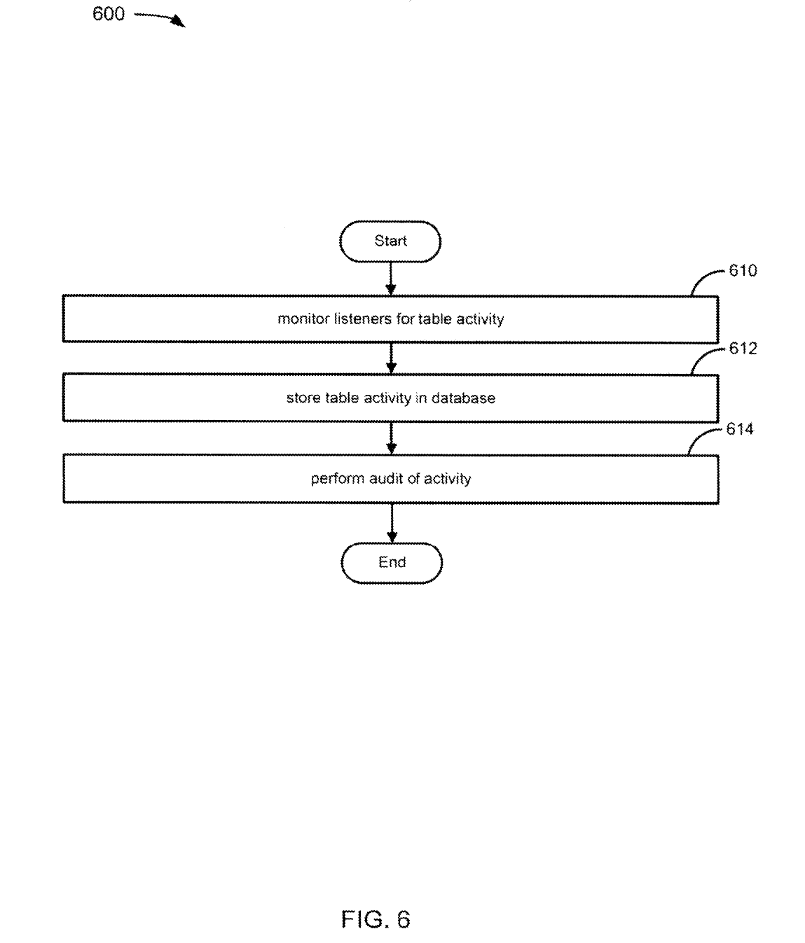

FIG. 6 depicts a flow chart 600 of an example of a method for managing a table within a player-to-player casino. The method is organized as a sequence of modules in the flowchart 600, however, it should be understood that these and other modules associated with other methods described herein may be reordered for parallel execution or into different sequences of modules.

In the example of FIG. 6, the flowchart starts at module 610 with monitor listeners for table activity. Software in memory, executing on a processor, can be used to provide the table with a listener, or function that collects table data. A management engine can collect the table activity or table data from the listener. The information can be useful for analysis of the activities on the table, such as for auditing and security purposes.

In the example of FIG. 6, the flowchart continues to module 612 with store table activity in database. The data received from the listener can be stored in a data storage repository, e.g. a database such as any discussed within this paper. The data can be organized by table, by game, by user, player, or any other known or convenient schema.

In the example of FIG. 6, the flowchart continues to module 614 with perform an audit of activity. The audit of the data collected from the listener can be analyzed, e.g. by a management engine for irregularities, insufficient funds, security breaches, user requirements or any known or convenient audit factor. Having performed an audit of activity, the flowchart terminates.

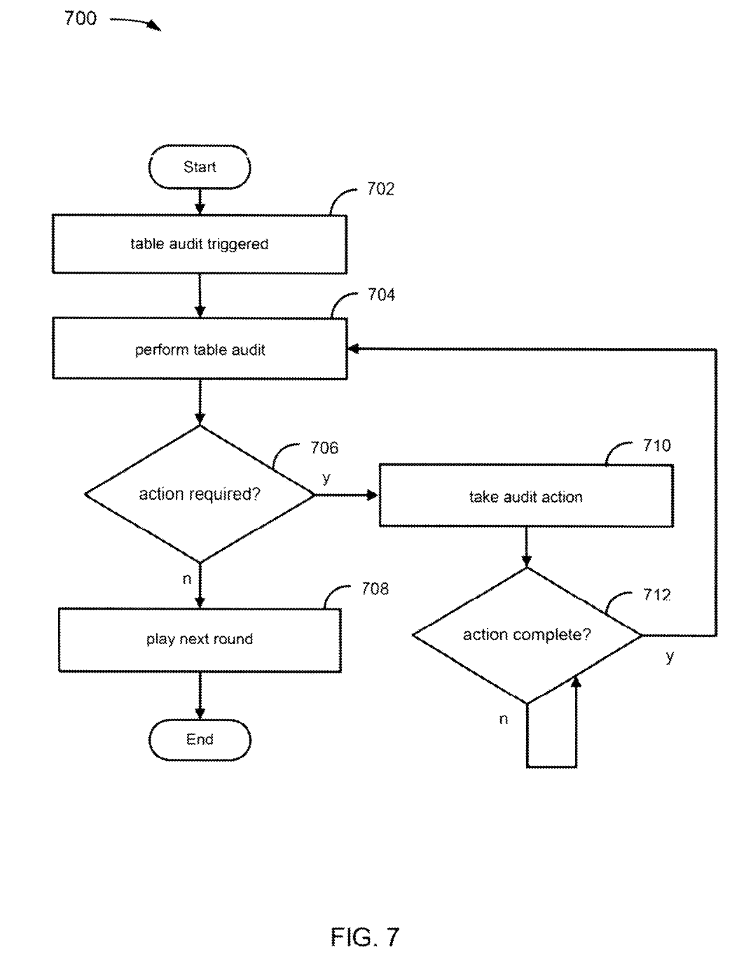

FIG. 7 depicts a flow chart 700 of an example of a method for auditing a table within a player-to-player casino. The method is organized as a sequence of modules in the flowchart 700, however, it should be understood that these and other modules associated with other methods described herein may be reordered for parallel execution or into different sequences of modules.

In the example of FIG. 7, the flowchart starts at module 702 with table audit triggered. A table audit can be triggered at the end of every round, where a security violation is detected, or where any known or convenient need for an audit is raised.

In the example of FIG. 7, the flowchart continues to module 704 with perform table audit. In performing the table audit, the auditing process can perform one or more tests required for the audit, including checking that sufficient funds are available for each user on the table, that any data, checksums or hash values are accurate, that user computing systems are all responding to requests or any other known or convenient test.

In the example of FIG. 7, the flowchart continues to decision module 706 with determining whether action is required. The decision can be yes where action is required and the decision can be no where action is not required. Action can be required by any rule controlling the table, e.g. a requirement of the game being played, insufficient funds, security violation, or other known or convenient requirement. For example, action can be required by the loss of player funds below a level at which the player could pay should he lose another round. If the decision at 706 is no the flowchart proceeds to module 708. If the decision at 706 is yes then the flowchart proceeds to module 710.

In the example of FIG. 7, if the decision at 706 is no, the flowchart continues from decision module 706 to module 708 with play next round. Assuming the audit has completed successfully, the next round can be played. Having played the next round, the flowchart terminates.

In the example of FIG. 7, if the decision at 706 is yes, the flowchart continues from decision module 706 to module 710 with take audit action. An individual audit action can be an action designed to remedy a particular issue, e.g., where there are insufficient funds the user can be required to add funds. Where there are not enough users to play the game, the game play can be halted while new users are identified. Any other audit action can be identified and applied as needed.

In the example of FIG. 7, the flowchart continues to decision module 712 with determining whether the action is complete. An action can require time to complete or may involve multiple steps. Where the table has not completed the current action or where a subsequent step is required in an action the flowchart remains at module 712 with evaluating and re-evaluating until such time as the audit action has been completed. The decision can be yes where the audit action has completed, or alternatively, the decision can be no where the action has not completed. If the decision at 712 is no the flowchart proceeds back to module 712. If the decision at 712 is yes then the flowchart proceeds back to module 704.

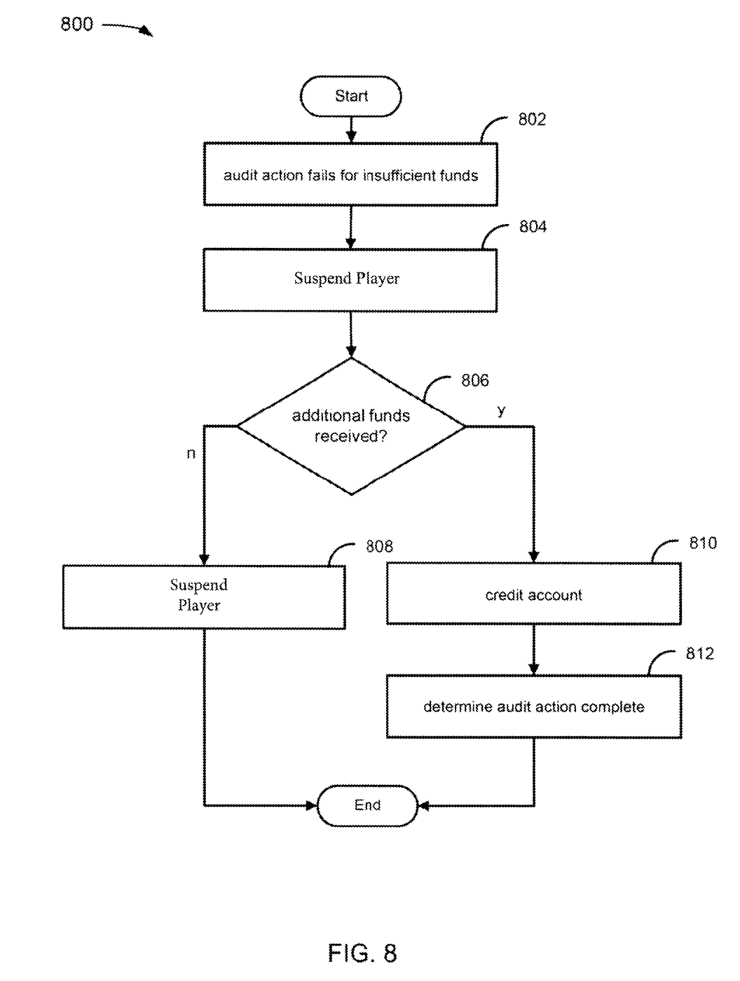

FIG. 8 depicts a flow chart 800 of an example of a method for managing a failed table audit within a player-to-player casino. The method is organized as a sequence of modules in the flowchart 800, however, it should be understood that these and other modules associated with other methods described herein may be reordered for parallel execution or into different sequences of modules.

In the example of FIG. 8, the flowchart starts at module 802 with audit action fails for insufficient funds. A user can be audited to determine whether the user has enough funds to cover all the bets they have placed or laid as house or player. A common audit failure will occur where a user has run out of money. Where a user has insufficient funds, and where no margin, loan or other system has been put into place to prevent a user from running out of funds, the audit action for sufficient funds can fail.

In the example of FIG. 8, the flowchart continues to module 804 with suspend table. If a user has insufficient funds he cannot be allowed to continue play until funds have been added to his account. A user can have a master account and a table account. Where only the table account is exhausted, the user can supply funds to the table account from the master account. Additionally a user can supply funds to the master account from outside sources. The table can be suspended when there are no users.

In the example of FIG. 8, the flowchart continues to decision module 806 with determining whether additional funds have been received. After a brief delay a check can be performed to determine Whether the user has added funds. Alternatively, the system can alert the management engine that the funds have been received and the decision module can be evaluated. The decision can be no where the funds have not been added and the decision can be yes where the funds have been added. If the decision at 806 is no, the flowchart proceeds to module 808 with closing the table. In closing the table, user accounts can be credited and the users disassociated from the table. Further the table can be removed from the list of active tables. Having closed the table, the flowchart terminates.

In the example of FIG. 8, if the decision at 806 is yes, the flowchart continues from decision module 806 to module 810 with credit account. Once the additional funds have been received the funds can be stored into an account associated with the table.

In the example of FIG. 8, the flowchart continues to module 812 with determine whether the audit action is complete. This entry can notify the management engine that the particular audit event associated with insufficient funds has been completed. If there are any other audit events unrelated to funding, they may need to be resolved before returning to play. Having determined that the audit action is complete, the flowchart terminates.

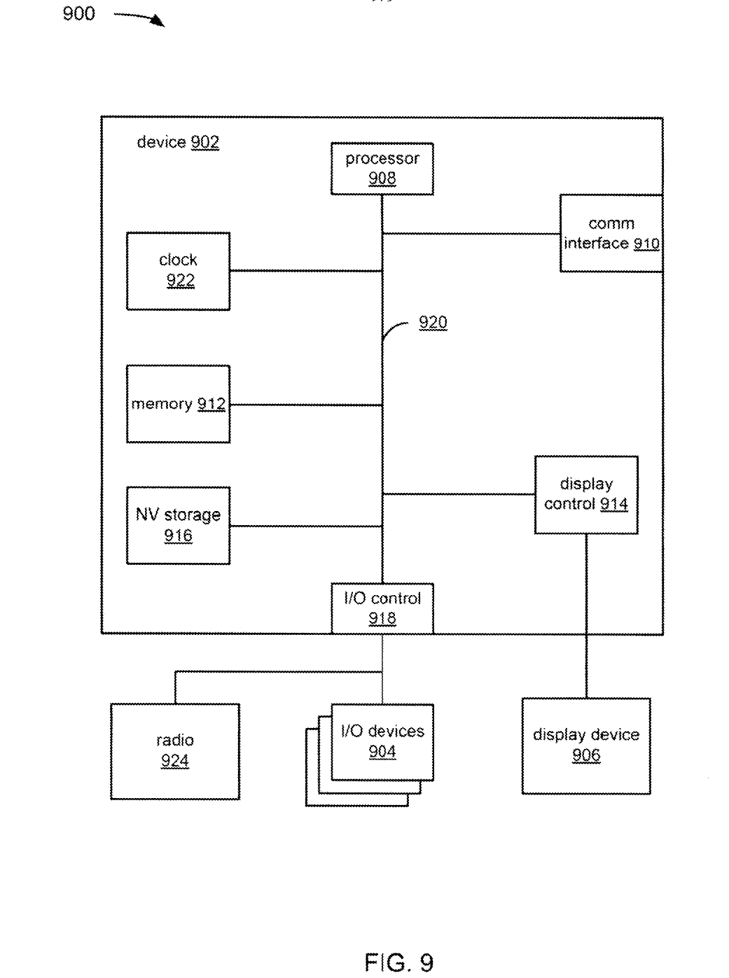

FIG. 9 depicts an example of a system for providing a player-to-player casino. The system 900 may be a conventional computer system that can be used as a client computer system, such as wireless client or a workstation, or a server computer system. The system 900 includes a device 902, I/O devices 904, and a display device 906. The device 902 includes a processor 908, a communications interface 910, memory 912, displayer controller 914, non-volatile storage 916, I/O controller 918, clock 922, and radio 924. The device 902 may be coupled to or include the I/O devices 904 and the display device 906.

The device 902 interfaces to external systems through the communications interface 910, which may include a modem or network interface. It will be appreciated that the communications interface 910 can be considered to be part of the system 900 or a part of the device 902. The communications interface 910 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 908 may be, for example, a conventional microprocessor such as an Intel Pentium microprocessor or Motorola power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

The I/O devices 904 can include a keyboard, disk drives, printers, a scanner, and other input and output devices, including a mouse or other pointing device. The display controller 914 may control in the conventional manner a display on the display device 906, which can be, for example, a cathode ray tube (CRT) or liquid crystal display (LCD). The display controller 914 and the I/O controller 918 can be implemented with conventional well known technology.

The non-volatile storage 916 is often a magnetic hard disk, flash memory, an optical disk, or another form of storage for large amounts of data. Some of this data is often written, by a direct memory access process, into memory 912 during execution of software in the device 912. One of skill in the art will immediately recognize that the terms “machine-readable medium” or “computer-readable medium” includes any type of storage device that is accessible by the processor 908.

Clock 922 can be any kind of oscillating circuit creating an electrical signal with a precise frequency. In a non-limiting example, clock 922 could be a crystal oscillator using the mechanical resonance of vibrating crystal to generate the electrical signal.

The radio 924 can include any combination of electronic components, for example transistors, resistors, and capacitors. The radio is operable to transmit and/or receive signals.

The system 900 is one example of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A typical computer system will usually include at least a processor, memory, and a bus coupling the memory to the processor.

In addition, the system 900 is controlled by operation system software which includes a file management system, such as a disk operating system, which is part of the operating system software. One example of operating system software with its associated file management system software is the family of operating systems known as Windows® from Microsoft Corporation of Redmond, Wash., and their associated file management system software is the Linux operating system and its associated file management system. The file management system is typically stored in the non-volatile storage 916 and causes the processor 908 to execute the various acts required by the operating system to input and output data and to store data in memory, including storing files on the non-volatile storage 916.

Some portions of the detailed description are presented in terms of algorithms and symbolic representations of operations on data bits within a computer memory. These algorithmic descriptions and representations are the means used by those skilled in the data of processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the link, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMS, and magnetic-optical disks, or any type of media suitable for storing electronic instructions, and each couple to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system for generating a peer-to-peer (p2p) casino game comprising:
a peer-to-peer (p2p) engine, wherein the p2p engine is configured to create a casino table for play between a first user making an initial wager and a second user making a cover wager that covers at least a portion of the initial wager;
an interface coupled to the p2p engine and configured to receive data from the first user and the second user; and
a management engine coupled to the p2p engine, wherein the management engine is configured to audit the casino table.

2. The system of claim 1, wherein the management engine is further configured to collect casino table activity data.

3. The system of claim 2, wherein the management engine is further configured to identify at least one trigger based on the casino table activity data and send an alert to at least one of the first user and the second user based on the trigger.

4. The system of claim 3, wherein the trigger is at least one of the first user making the initial wager, at least one of the first user and the second user winning more than a predetermined threshold amount of money, at least one of the first user and the second user losing more than a second predetermined threshold amount of money, a particular user placing a second initial wager, a particular casino game being associated with the initial wager.

5. The system of claim 1, wherein the management engine is further configured to automatically match the first user with the second user based on the initial wager.

6. The system of claim 1, wherein the initial wager is associated with a table game operated by a live dealer.

7. The system of claim 1, wherein the management engine is further configured to determine an amount of funds in a first user account and a second user account;
suspend wagering on the casino table by the first user if the amount of funds in the first user account is less than a first predetermined threshold; and
suspend wagering on the casino table by the second user if the amount of in the second user account is less than a second predetermined threshold.

8. The system of claim 7, wherein the first predetermined threshold is determined based on the initial wager and the second predetermined threshold is determined based on a maximum payout of the cover wager.

9. The system of claim 1, wherein the p2p engine is further configured to receive a second initial wager from a third user and a second cover wager from the first user.

10. The system of claim 1, wherein the p2p engine is further configured to receive a second cover wager from a third user that covers at least a portion of the initial wager.

11. The system of claim 1, wherein the p2p engine is further configured to lay at least one unmatched initial wager with a predetermined user that acts as a house.

12. The system of claim 1, wherein the p2p engine is configured to receive table specifications from the first user, and the casino table is configured based on the table specifications.

13. The system of claim 12, wherein the table specifications include a privacy setting that allows only invited users to join the casino table.

14. The system of claim 1, wherein the first user is associated with a set of betting specifications, and the initial wager is automatically placed based on the betting specifications.

15. The system of claim 14, wherein the betting specifications include a predefined betting strategy associated with the casino table.

16. A method of generating a p2p casino game, said method implemented with a processor coupled to a memory, said method including:
creating, with a p2p engine, a casino table for play between a first user making an initial wager and a second user making a cover wager that covers at least a portion of the initial wager;
receiving data from the first user and the second user through an interface; and
auditing the casino table with a management engine.

17. The method of claim 11 further comprising:
collecting casino table activity data;
identifying at least one trigger based on the casino table activity data; and
sending an alert to at least one of the first user and the second user based on identifying the trigger.

18. The method of claim 11 further comprising determining an amount of funds in a first user account; and
suspending wagering by the first user if the amount of funds in the first user account is less than a predetermined threshold.

19. The method of claim 11 further comprising reconciling a first user account and a second user account based on an outcome of a table game played on the casino table.

20. A computer readable medium having computer-executable instructions for generating a p2p casino table, wherein, when executed by a processor, the computer-executable instructions cause the processor to:
create a casino table for play between a first user making an initial wager and a second user making a cover wager that covers at least a portion of the initial wager;
receive data from the first user and the second user; and
audit the casino table.
